(19) United States
(12) Patent Application Publication
(10) Pub. No.: US 2026/0269871 A1
(43) Pub. Date: Sep. 10, 2026

(54) METHODS, DEVICES, AND COMPUTER PROGRAM FOR UPLINK COMMUNICATION

(71) Applicant: Telefonaktiebolaget LM Ericsson (publ), Stockholm (SE)

(72) Inventors: Sven JACOBSSON, Västra Frölunda (SE); Andreas NILSSON, Göteborg (SE); Magnus NILSSON, Kungsbacka (SE); Mikael COLDREY, Borås (SE); Sam AGNEESSENS, Torslanda (SE)

(73) Assignee: Telefonaktiebolaget LM Ericsson (publ), Stockholm (SE)

(21) Appl. No.: 19/135,899

(22) PCT Filed: Dec. 9, 2022
(86) PCT No.: PCT/EP2022/085225

§ 371 Date: Jun. 5, 2025

(30) Foreign Application Priority Data
Dec. 8, 2022 (WO) PCT/EP2022/084930

(51) Int. Cl. H04B 7/026; H04W 72/21; H04W 84/00

(52) U.S. Cl. CPC H04B 7/026; H04W 72/21; H04W 84/005

(57) ABSTRACT

There is provided techniques for uplink communication with a network node. A method is performed by a transceiver device. The method comprises exchanging signaling with the network node to form a RVUE, constituted by a group of transceiver devices. The transceiver device is part of the group of transceiver devices. The signaling at least indicates available number of antenna ports of the RVUE for communication with the network node, and maximally support transmission rank for the RVUE. The method comprises receiving configuration from the network node for uplink transmission from the RVUE to the network node. The configuration at least indicates which transmission rank for the RVUE to use, and a mapping of transmission layers to the antenna ports in the RVUE. The method comprises performing uplink transmission towards the network node in accordance with the received configuration.

### TECHNICAL FIELD

Embodiments presented herein relate to a method, a transceiver device, a computer program, and a computer program product for uplink communication with a network node. Embodiments presented herein further relate to a method, a network node, a computer program, and a computer program product for configuring a group of transceiver devices, constituting a reconfigurable virtual user equipment (RVUE), for uplink communication.

### BACKGROUND

Some communication nodes, such as access points or other types of nodes at the network side but also user equipment (UEs) or other types of devices at the user side, can form a network by establishing connectivity between the communication nodes. A network of such communication nodes can constitute of wireless connections, wired connections, or a combination of both. Typically, the communication nodes communicate with each other in the network according to some predefined interface. In general terms, UEs served in a (radio) access network can form a network with other UEs. In such a network, the UEs might communicated directly with each other, or at least without utilizing any cellular connectivity. For example, the UEs might communicate with each other by using Bluetooth connectivity or side-link connectivity.

The network can be static, semi-static or fully flexible with respect to its members. For example, communication nodes could be enabled to join and/or leave semi-static or fully flexible networks. Examples of networks are local computer networks where communication nodes in the form of computers can be added or removed from the local computer network and where communication within the network is facilitated using wired Ethernet links or wireless Wi-Fi links.

Compared to co-located multiple input multiple output (MIMO) systems, distributed MIMO (D-MIMO) systems provide better coverage and multi-user connectivity by making use of joint processing from many access points (for example in terms of Remote Radio Units (RRUs)) that are distributed over a deployment area. The likelihood of a served user being close and having a good connection to one such access point is high. Further, the likelihood of shadowing and the likelihood of having correlated MIMO channels are reduced compared to co-located MIMO systems. Further, D-MIMO systems also bring higher system and link capacity, compared to co-located MIMO systems, at the expense of more complex deployment and more transport needs.

A given UE can have poor connectivity to its serving access points in the serving cellular network due to, e.g., shadowing or interference. Good cellular connectivity, especially at higher frequencies, require a dense network deployment, such as densely deployed co-located MIMO system or even a D-MIMO system. Such systems are complex (in terms of hardware and software) and drives cost. In addition to this, a given UE might need to support many different frequencies, bandwidths, and communication standards which makes the UE complex (in terms of hardware and software), bulky, and costly.

### SUMMARY

An object of embodiments herein is to address the above issues by providing improved uplink communication for a group of transceiver devices.

According to a first aspect there is presented a method for uplink communication with a network node. The method is performed by a transceiver device. The method comprises exchanging signaling with the network node to form a RVUE, constituted by a group of transceiver devices. The transceiver device is part of the group of transceiver devices. The signaling at least indicates available number of antenna ports of the RVUE for communication with the network node, and maximally support transmission rank for the RVUE. The method comprises receiving configuration from the network node for uplink transmission from the RVUE to the network node. The configuration at least indicates which transmission rank for the RVUE to use, and a mapping of transmission layers to the antenna ports in the RVUE. The method comprises performing uplink transmission towards the network node in accordance with the received configuration.

According to a second aspect there is presented a transceiver device for uplink communication with a network node. The transceiver device comprises processing circuitry. The processing circuitry is configured to cause the transceiver device to exchange signaling with the network node to form a RVUE, constituted by a group of transceiver devices. The transceiver device is part of the group of transceiver devices. The signaling at least indicates available number of antenna ports of the RVUE for communication with the network node, and maximally support transmission rank for the RVUE. The processing circuitry is configured to cause the transceiver device to receive configuration from the network node for uplink transmission from the RVUE to the network node. The configuration at least indicates which transmission rank for the RVUE to use, and a mapping of transmission layers to the antenna ports in the RVUE. The processing circuitry is configured to cause the transceiver device to perform uplink transmission towards the network node in accordance with the received configuration.

According to a third aspect there is presented a transceiver device for uplink communication with a network node. The transceiver device comprises a signal module configured to exchange signaling with the network node to form a RVUE, constituted by a group of transceiver devices. The transceiver device is part of the group of transceiver devices. The signaling at least indicates available number of antenna ports of the RVUE for communication with the network node, and maximally support transmission rank for the RVUE. The transceiver device comprises a receive module configured to receive configuration from the network node for uplink transmission from the RVUE to the network node. The configuration at least indicates which transmission rank for the RVUE to use, and a mapping of transmission layers to the antenna ports in the RVUE. The transceiver device comprises a transmit module configured to perform uplink transmission towards the network node in accordance with the received configuration.

According to a fourth aspect there is presented a computer program for uplink communication with a network node. The computer program comprises computer code which, when run on processing circuitry of a transceiver device, causes the transceiver device to perform actions. One action comprises the transceiver device to exchange signaling with the network node to form a RVUE, constituted by a group of transceiver devices. The transceiver device is part of the group of transceiver devices. The signaling at least indicates available number of antenna ports of the RVUE for communication with the network node, and maximally support transmission rank for the RVUE. One action comprises the transceiver device to receive configuration from the network node for uplink transmission from the RVUE to the network node. The configuration at least indicates which transmission rank for the RVUE to use, and a mapping of transmission layers to the antenna ports in the RVUE. One action comprises the transceiver device to perform uplink transmission towards the network node in accordance with the received configuration.

According to a fifth aspect there is presented a method for configuring a group of transceiver devices for uplink communication. The method is performed by a network node. The method comprises exchanging signaling with one of the transceiver devices in the group of transceiver devices to form a RVUE, constituted by the group of transceiver devices. The signaling at least indicates available number of antenna ports of the RVUE for communication with the network node, and maximally support transmission rank for the RVUE. The method comprises configuring the RVUE for uplink transmission from the RVUE to the network node as a function of the available number of antenna ports of the, and the maximally support transmission rank. The configuring at least indicates which transmission rank for the RVUE to use, and a mapping of transmission layers to the antenna ports in the RVUE. The method comprises receiving uplink transmission from the RVUE in accordance with the configuration.

According to a sixth aspect there is presented a network node for configuring a group of transceiver devices for uplink communication. The network node comprises processing circuitry. The processing circuitry is configured to cause the network node to exchange signaling with one of the transceiver devices in the group of transceiver devices to form a RVUE, constituted by the group of transceiver devices. The signaling at least indicates available number of antenna ports of the RVUE for communication with the network node, and maximally support transmission rank for the RVUE. The processing circuitry is configured to cause the network node to configure the RVUE for uplink transmission from the RVUE to the network node as a function of the available number of antenna ports of the, and the maximally support transmission rank. The configuring at least indicates which transmission rank for the RVUE to use, and a mapping of transmission layers to the antenna ports in the RVUE. The processing circuitry is configured to cause the network node to receive uplink transmission from the RVUE in accordance with the configuration.

According to a seventh aspect there is presented a network node for configuring a group of transceiver devices for uplink communication. The network node comprises a signal module configured to exchange signaling with one of the transceiver devices in the group of transceiver devices to form a RVUE, constituted by the group of transceiver devices. The signaling at least indicates available number of antenna ports of the RVUE for communication with the network node, and maximally support transmission rank for the RVUE. The network node comprises a configure module configured to configure the RVUE for uplink transmission from the RVUE to the network node as a function of the available number of antenna ports of the, and the maximally support transmission rank. The configuring at least indicates which transmission rank for the RVUE to use, and a mapping of transmission layers to the antenna ports in the RVUE. The network node comprises a receive module configured to receive uplink transmission from the RVUE in accordance with the configuration.

According to an eighth aspect there is presented a computer program for configuring a group of transceiver devices for uplink communication. The computer program comprises computer code which, when run on processing circuitry of a network node, causes the network node to perform actions. One action comprises the network node to exchange signaling with one of the transceiver devices in the group of transceiver devices to form a RVUE, constituted by the group of transceiver devices. The signaling at least indicates available number of antenna ports of the RVUE for communication with the network node, and maximally support transmission rank for the RVUE. One action comprises the network node to configure the RVUE for uplink transmission from the RVUE to the network node as a function of the available number of antenna ports of the, and the maximally support transmission rank. The configuring at least indicates which transmission rank for the RVUE to use, and a mapping of transmission layers to the antenna ports in the RVUE. One action comprises the network node to receive uplink transmission from the RVUE in accordance with the configuration.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects can reduce the overhead for uplink communication when the transceiver devices collaboratively act as one RVUE, compared to the overhead for individual uplink communication for the transceiver devices.

Advantageously, these aspects can improve the throughput for uplink communication when the transceiver devices collaboratively act as one RVUE, compared to the throughput for individual uplink communication for the transceiver devices.

Advantageously, these aspects can improve the uplink communication diversity when the transceiver devices collaboratively act as one RVUE, compared to the diversity for individual uplink communication for the transceiver devices.

Advantageously, these aspects can improve the robustness towards blocking during uplink communication when the transceiver devices collaboratively act as one RVUE, compared to the robustness towards blocking during individual uplink communication for the transceiver devices.

Advantageously, these aspects can be used to reduce the energy consumption for uplink communication when the transceiver devices collaboratively act as one RVUE, compared to the energy consumption for individual uplink communication for the transceiver devices.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic illustration of a group of transceiver devices according to an example;

FIG. 2 is a schematic illustration of an RVUE according to an embodiment;

FIG. 3 is a schematic illustration of an RVUE communicating with a network node according to an embodiment;

FIG. 4 is a schematic illustration of an RVUE according to an embodiment;

FIGS. 5 and 6 are flowcharts of methods according to embodiments;

FIGS. 7, 8, 9, and 10 are schematic illustrations of uplink transmission from a RVUE according to embodiments;

FIG. 11 is a schematic diagram showing functional units of a transceiver device according to an embodiment;

FIG. 12 is a schematic diagram showing functional modules of a transceiver device according to an embodiment;

FIG. 13 is a schematic diagram showing functional units of a network node according to an embodiment;

FIG. 14 is a schematic diagram showing functional modules of a network node according to an embodiment; and

FIG. 15 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

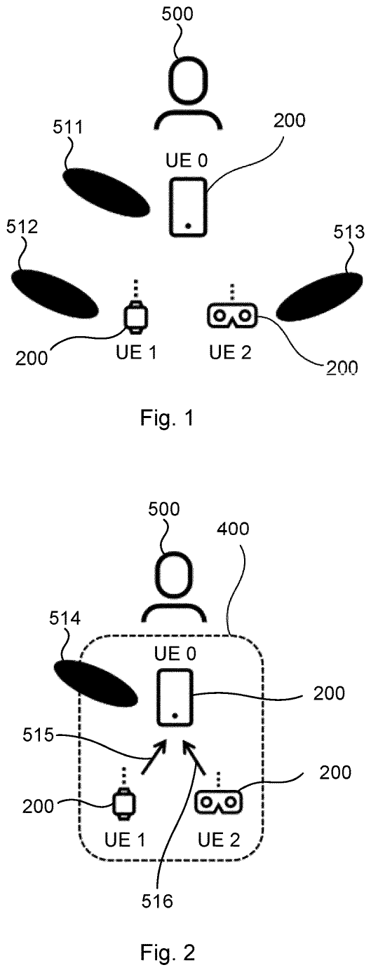

FIG. 1 illustrates a traditional scenario where three different transceiver devices 200 (in terms of a conventional UE, a smart watch and an extended reality (XR headset) belonging to the same user 500 are configured for individual and independent communication, as illustrated by beams 511, 512, 513, with a network. When configured for individual and independent communication with the network, each of the transceiver devices 200 might need to support many different frequencies, bandwidths, and communication standards. This makes the transceiver devices 200 complex (in terms of hardware and software), bulky, and costly.

In contrast to FIG. 1, in FIG. 2 is illustrated a scenario with the same three different transceiver devices 200 as in FIG. 1, but where the transceiver devices 200 are configured to collaborate with each other as a group of transceiver devices. More particularly, the transceiver devices 200 are configured to communicate with each other, as indicated by links 515, 516, but when communicating with the network, the transceiver devices 200 appear one single device, hereinafter referred to as a RVUE 400. This is illustrated by beam 514 used by the RVUE 400 for communicating with the network-The herein disclosed embodiments are based on such a group of transceiver devices 200, together constituting an RVUE 400. An RVUE 400 is thus constituted by a group of transceiver devices 200. Each such transceiver device 200 may or may not have its own individual network identity. It is sufficient that at least one of the transceiver devices 200 has its own individual network identity. For this purpose, at least one of the transceiver devices 200 needs to be provided with a Subscriber Identity Module or Subscriber Identification Module (SIM). The SIM might be provided in terms of a traditional SIM card, or by an embedded SIM (eSIM) or an integrated SIM (iSIM). In some examples, each of the transceiver devices 200 is provided with hardware that enables each of the transceiver devices 200 to independently connect to the network. In this way, even if only one of the transceiver devices 200 is provided with a SIM, all of the transceiver devices 200 can be used for communication with the network when the transceiver devices 200 collaborate with each other as a group of transceiver devices 200 constituting an RVUE 400. In some embodiments, at least one of the transceiver devices 200 in the group of transceiver devices 200 (that constitute an RVUE 400) comprises a cellular modem and has a cellular network identity. In some embodiments, each of the transceiver devices 200 in the group of transceiver devices 200 (that constitute an RVUE 400) comprises a signaling interface for non-cellular communication with other transceiver devices 200 in the group of transceiver devices 200. In some embodiments the the RVUE 400 can be seen as a device-centric network that shares resources. Examples of such resources can be processing, power amplifiers, antennas, identities, etc. In some embodiments, at least one of the transceiver devices 200 in the group of transceiver devices 200 has a network identity, and the network identity is used by the network node 300 when communicating with the RVUE 400 in accordance with RVUE 400 configurations. In some examples, the RVUE 400 configuration comprises instructions that the RVUE 400 is to be formed by at least two transceiver devices 200 in the group of transceiver devices. For alternative characterizations of an RVUE 400 and related technical information, reference is made to the applicant's parallel disclosures [applicant reference: P105673WO01] and [applicant reference: P106173WO01], which are hereby incorporated by reference.

The transceiver devices 200 are operatively connectable to each other via any proprietary or standardized, wired, or wireless, technology. The transceiver device 200 of each RVUE 400 can belong to the same user or can be shared between multiple users. By forming a RVUE 400, the connection to the network for the transceiver devices 200 is improved compared to the connection to the network for just one single transceiver device 200. The RVUE 400 enables diversity and/or multiplexing over multiple spatially separated devices. Each transceiver device 200 can have its own unique characteristics, for example, having its operations optimized for a certain frequency band or deployment location. Some non-limiting examples of transceiver devices 200 are consumer premises equipment (CPEs), UEs (such as mobile phones, tablet computers, laptop computers, etc.), smart wearables (such as smart watches, smart glasses, etc.), relays, repeaters, modems, routers, remote radio units (RRUs), network connectible vehicles (such as unmanned aerial vehicles, self-driving cars, etc.), network connectible machines and industry equipment, etc. As a first non-limiting example, consider a set of smart wearables operatively connected to one and the same UE. The smart wearables and the UE could then constitute a RVUE 400. As a second non-limiting example, consider a set of communication equipment composed of a UE, a tablet computer, and a laptop computer belonging to one and the same user. The set of communication equipment could then constitute an RVUE 400. As a third non-limiting example, consider a set of communication equipment composed of a modem, a router, and a computer connected to one and the same local-area network. The set of communication equipment could then constitute an RVUE 400. As a fourth non-limiting example, consider a set of communication equipment composed of two or more UEs, tablet computers, laptop computers, etc. placed in one and the same vehicle (such as a car, a bus, a train car, etc.). The set of communication equipment could then constitute an RVUE 400. As a fourth non-limiting example, consider a set of communication equipment composed of one or more UEs and a network connectible vehicle, where the one or more UEs are placed in the network connectible vehicle. In this respect, the hardware capabilities of the network connectible vehicle can be much better than for the UEs, in terms of more output power, better synchronization between transmitters, more and larger antenna panels, antenna panels placed on the exterior of the vehicle with line of sight to the serving access point, etc. In this case, the UEs and the network connectible vehicle may be configured as a virtual UE, where data from all the communication equipment is routed to the network via the network connectible vehicle. As a fourth non-limiting example, consider a set of communication equipment composed of integrated access and backhaul (IAB) nodes operatively connected to the same donor IAB node. The IAB nodes could then constitute an RVUE 400. Each IAB node is equipped with at least one antenna port for communication with the network, whereas the transmission between the IAB nodes and the donor IAB node is performed via the Uu interface. The IAB nodes can be connected to each other over an alternative interface and, hence, can exchange data with each other without the network being involved.

In some examples, one of the transceiver devices 200 constituting the RVUE 400 acts as a coordinating transceiver device 200 in the group of the transceiver devices 200. This coordinating transceiver device 200 might then be configured for coordinating joint processing and transmission/reception over the group of the transceiver devices 200.

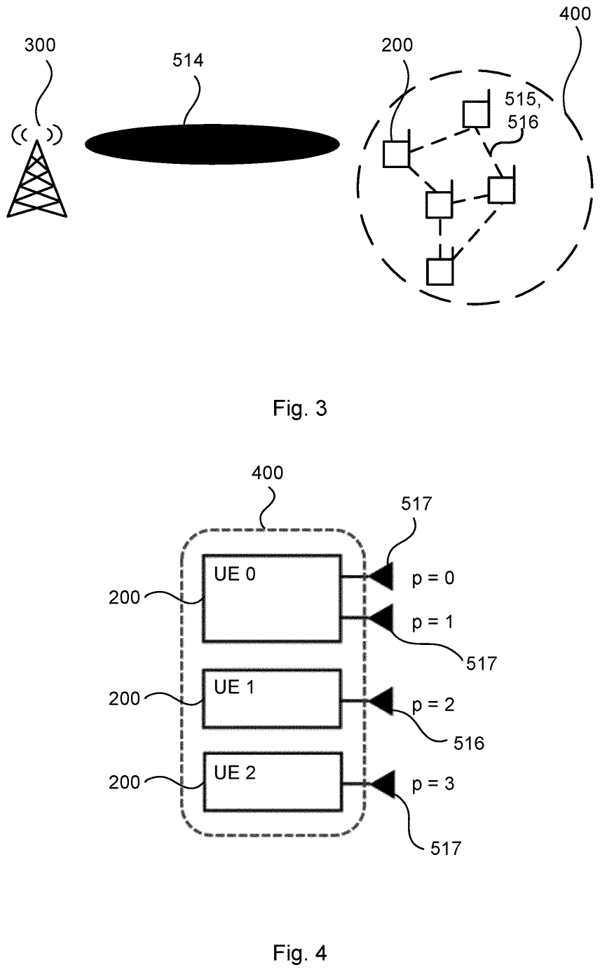

In FIG. 3 is illustrated a scenario where transceiver devices 200, by means of the RVUE 400, communicate in a beam 514 with a network node 300. The network node 300 could be any of a (radio) access network node, radio base station, base transceiver station, node B (NB), evolved node B (eNB), gNB, access point, etc. Since the RVUE 400 is constituted by spatially separated devices with possibly different connection capabilities, the likelihood of good network connectivity thanks to spatial diversity and/or multiplexing over transceiver devices 200 is increased compared to the network capability per each individual transceiver device 200. The network node 300 would recognize the RVUE 400 as a single transceiver device 200 but with possibly increases capacity and/or capability compared to an individual transceiver device 200. This could be useful for adding spatial diversity and/or multiplexing to improve performance without exposing each individual transceiver device 200 to the network.

In general terms, combinations of transceiver devices 200 with different capabilities yield different capabilities of the RVUE 400. One example of this is illustrated in FIG. 4. In FIG. 4 is illustrated an example RVUE 400 with four antennas 517 in total, The RVUE 400 is constituted by a smartphone (UE 0), a smart watch (UE 1) and an XR headset (UE 2), where the smartphone (UE 0) has one dual-port antenna panel (p=0 and p=1), the smart watch (UE 1) has one single-port antenna panel (p=2), and the XR headset (UE 2) has one single-port antenna panel (p=3) for communicating with the network. When operating as individual devices, the devices thus have either one or two antenna ports for communicating with the network. By forming an RVUE 400, the devices now instead share a total of four antenna ports (p=0, . . . p=3) for communicating with the network.

In general terms, depending on the number of available antenna ports, there could be different available schemes for precoded transmission. Such precoded transmission could be based on codebooks.

In general terms, non-coherent codebook-based precoding refers to precoding where a number of precoders is used for UEs that cannot coherently combine signals transmitted from different antenna ports. These precoders are pure antenna selection precoders. That is, there is not any combining of signals between two or more antenna ports.

Partially coherent codebook-based precoding refers to precoding where a number of precoders is used for UEs that can combine signals coherently over a subset of the antenna ports but cannot coherently combine signals transmitted from another subset of the antenna ports. These precoders are a mix between port combining precoders and antenna selection precedes. That is, only a subset of the antenna ports can be combined together.

Fully coherent codebook-based precoding refers to precoding where a number of precoders is used for UEs that can combine signals coherently over all the antenna ports. These precoders can thus combine signals over all the antenna ports.

It is here noted that although some terms that are used in Long Term Evolution (LTE) or New Radio (NR) based systems, such as sounding reference signals (SRS), physical uplink shared channel (PUSCH), codebook-based uplink transmission, non-coherent, partially coherent and fully coherent codebooks, etc. the herein disclosed embodiments are not limited to these particular signals or concepts. Rather, these are to be construed as illustrative examples intended to provide a better understanding of the herein disclosed inventive concepts. For example, an SRS is an example of an uplink reference signal used to sound the uplink channel and/or the downlink channel. Such an uplink reference signal can, for example, be used to estimate the downlink channel for reciprocity-based downlink transmission or for codebook-based uplink transmissions. For example, PUSCH is an example of a channel used to for transmission of data and/or control information in the uplink.

In current cellular communication systems (e.g., using the Long Term Evolution (LTE) air interface or the New Radio (NR) air interface), uplink transmissions (e.g., codebook-based precoded uplink data transmissions and transmissions of uplink reference signals) are configured per antenna panel per transceiver device 200). If the transceiver devices 200 are capable of being inter-connected to form a group of transceiver devices 200 constituting an RVUE 400 as disclosed above, this limitation results in unnecessary overhead and limits the system throughput.

The herein disclosed embodiments enable the network node 300 to configure the transceiver devices 200 for uplink transmissions over a plurality of the transceiver devices 200. This is made possible by an RVUE 400 being constituted by a group of the transceiver devices 200. Examples of uplink transmissions will be disclosed below.

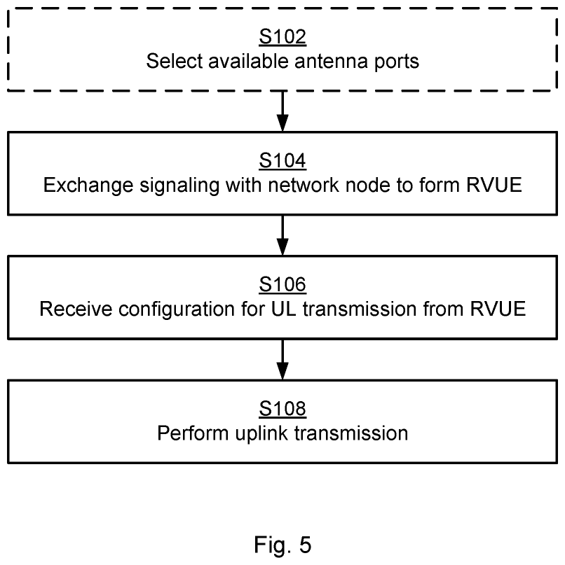

Reference is now made to FIG. 5 illustrating a method for uplink communication with a network node 300 as performed by the transceiver device 200 according to an embodiment.

It is assumed that a group of transceiver devices 200 has been configured to form a RVUE 400 and that the network node 300 is made aware of this.

S104: The transceiver device 200 exchanges signaling with the network node 300 to form a RVUE 400, constituted by a group of transceiver devices 200. The transceiver device 200 is part of the group of transceiver devices 200. The signaling at least indicates available number of antenna ports of the RVUE 400 for communication with the network node 300, and maximally support transmission rank for the RVUE 400.

The information could be signaled from each transceiver device 200 separately, or from one of the transceiver devices 200 in the group of transceiver devices 200 on behalf of all transceiver devices 200 that constitute the RVUE 400. For example, the information could be signaled as part of device capability signaling. Based on this information, the network node 300 can configure the RVUE 400, and thus the transceiver devices 200 constituting the RVUE 400, for uplink transmission.

S106: The transceiver device 200 receives configuration from the network node 300 for uplink transmission from the RVUE 400 to the network node 300. The configuration at least indicates which transmission rank for the RVUE 400 to use, and a mapping of transmission layers to the antenna ports in the RVUE 400.

That is, the network node 300 can configure the over a subset, or all, antenna ports of the transceiver device 200 that constitute the RVUE 400. Different types of uplink transmission will be disclosed below. The transceiver device 200 the follows the configuration when performing its uplink transmission.

S108: The transceiver device 200 performs uplink transmission towards the network node 300 in accordance with the received configuration.

Embodiments relating to further details of uplink communication with a network node 300 as performed by the transceiver device 200 will now be disclosed with continued reference to FIG. 5.

### Details of the Signaling in Step S104 Will Be Disclosed Next,

In some embodiments, the signaling further indicates any of number of transceiver devices 200 in the group of transceiver devices 200, number of antenna ports per transceiver device 200 in the group of transceiver devices 200, supported bandwidth per transceiver device 200 in the group of transceiver devices 200, coherency capability per transceiver device 200 in the group of transceiver devices 200, maximum transmit power per transceiver device 200 in the group of transceiver devices 200, which uplink reference signal resource, or port, that corresponds to which transceiver device 200 in the group of transceiver devices 200.

In addition to the parameters included in the configuration that are listed in conjunction with step S106, there might be further parameters included in the configuration.

In some embodiments, the configuration further indicates any of a precoder to be used for codebook-based uplink transmission, a set of spatial filters to be used for non-codebook-based uplink transmission, a waveform to be used for the uplink communication. Different waveforms could be used for uplink (and downlink) transmissions.

Different examples of uplink transmission will be disclosed next.

The uplink transmission is either an uplink data transmission or a transmission of an uplink reference signal.

In some examples, the uplink transmission is a codebook-based precoded uplink data transmission, such as a codebook-based precoded physical uplink shared channel (PUSCH) transmission.

In some examples, the codebook is selected over multiple transceiver devices 200 belonging to the same RVUE 400. That is, in some examples, according to the configuration, the codebook-based precoded uplink data transmission is to be performed jointly over at least two of the transceiver devices 200 in the group of transceiver devices 200.

In some examples, a non-coherent codebook is selected over ports belonging to different antenna panels, or transceiver devices 200 belonging to the same RVUE 400. That is, in some examples, according to the configuration, non-coherent codebook-based precoded uplink data transmission is to be performed over antenna ports belonging to different ones of the transceiver devices 200 in the group of transceiver devices 200.

In some examples a non-, partially-, or fully-coherent codebook is selected over ports belonging to the same antenna panel, or transceiver device 200 of the RVUE 400. That is, in some examples, according to the configuration, non-coherent, partially-coherent, or fully-coherent codebook-based precoded uplink data transmission is to be performed over antenna ports belonging to one and the same transceiver device 200 in the group of transceiver devices 200.

In some examples, the uplink transmission is a non-codebook-based precoded uplink data transmission, such as a non-codebook-based precoded physical uplink shared channel (PUSCH) transmission.

In some examples, one SRS resource, or SRS resource set, is configured over multiple transceiver devices 200 belonging to the same RVUE 400. That is, in some examples, according to the configuration, one uplink reference signal resource or a common set of uplink reference signal resources is configured over the transceiver devices 200 in the group of transceiver devices 200.

It might be so that the available number of antenna ports is less than the total number of antenna ports of the RVUE 400. The transceiver device 200 might then perform (optional) step S102.

S102: The transceiver device 200 selects the available antenna ports from the total antenna ports of the RVUE 400.

Only using a subset of the total antenna ports of the RVUE 400 at a given time could be used to minimize, or at least reduce, the uplink overhead.

Details of how the selection can be made will be disclosed next.

In some embodiments, the selecting is based on at least one of signal quality, capacity, of signaling interfaces between the transceiver devices 200 in the group of transceiver devices 200.

For non-codebook-based operation, normally one PUSCH layer is associated with each SRS resource. Furthermore, each SRS resource corresponds to a spatial filter (i.e., a transceiver device 200 may have virtualized its ports in some way or the spatial filter corresponds to one antenna port). If the network node 300 knows which SRS resources belongs to which transceiver device 200, the network node 300 can turn transceiver devices 200 on/off in the RVUE 400 by indicating which SRS resources and/or SRS resource sets that should be used for transmitting PUSCH from the RVUE 400.

For codebook-based operation, the network node 300 could indicate SRS resources/sets similar to the above and (1) signal one codebook for each SRS resource, or (2) signal one codebook over (an indicated subset of) ports in the indicated SRS resources, or (3) signal one codebook over all ports of all transceiver device 200 and where this codebook may contain zero rows so that some transceiver devices 200 will not transmit, or (4) signals some bitmap over which ports over which the precoder applies.

In the above, spatial division multiplexing is assumed. I.e., there is a separate precoding vector/spatial filter for each layer. Further, one and the same layer can be transmitted from multiple transceiver device 200 in the RVUE 400 to increase reliability.

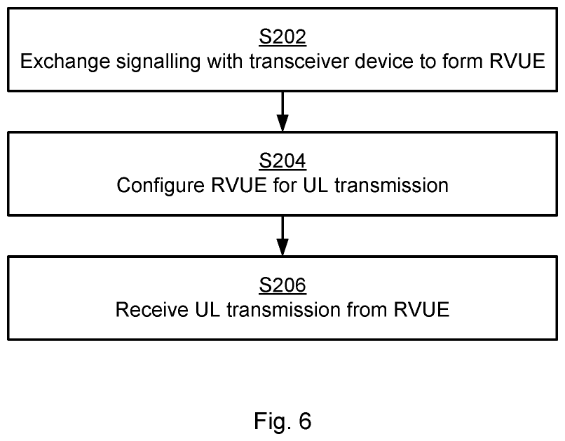

Reference is now made to FIG. 6 illustrating a method for configuring a group of transceiver devices 200 for uplink communication as performed by the network node 300 according to an embodiment.

As above, it is assumed that a group of transceiver devices 200 has been configured to form a RVUE 400 and that the network node 300 is made aware of this.

S202: The network node 300 exchanges signaling with one of the transceiver devices 200 in the group of transceiver devices 200 to form a RVUE 400, constituted by the group of transceiver devices 200. The signaling at least indicates available number of antenna ports of the RVUE 400 for communication with the network node 300, and maximally support transmission rank for the RVUE 400.

Upon receiving such signaling, the network node 300 configures uplink transmissions over a plurality of panels/ports belonging to the group of transceiver devices 200 by treating the group of transceiver devices 200 as one RVUE 400 in a way to enable overhead efficient and high performing uplink transmissions. This is achieved by selecting the configuration parameters only for one of the transceiver devices 200 and/or by informing only one of the transceiver devices 200 of the configuration parameters.

S204: The network node 300 configures the RVUE 400 for uplink transmission from the RVUE 400 to the network node 300 as a function of the available number of antenna ports of the, and the maximally support transmission rank. The configuring at least indicates which transmission rank for the RVUE 400 to use, and a mapping of transmission layers to the antenna ports in the RVUE 400.

As disclosed above, the transceiver devices 200 the follow the configuration when performing their uplink transmissions.

S206: The network node 300 receives uplink transmission from the RVUE 400 in accordance with the configuration.

Embodiments relating to further details of configuring a group of transceiver devices 200 for uplink communication as performed by the network node 300 will now be disclosed with continued reference to FIG. 6. As disclosed above, in some examples, the signaling further indicates any of number of transceiver devices 200 in the group of transceiver devices 200, number of antenna ports per transceiver device 200 in the group of transceiver devices 200, supported bandwidth per transceiver device 200 in the group of transceiver devices 200, coherency capability per transceiver device 200 in the group of transceiver devices 200, maximum transmit power per transceiver device 200 in the group of transceiver devices 200, which uplink reference signal resource, or port, that corresponds to which transceiver device 200 in the group of transceiver devices 200.

As disclosed above, in some examples, the configuration further indicates any of a precoder to be used for codebook-based uplink transmission, a set of spatial filters to be used for non-codebook-based uplink transmission, a waveform to be used for the uplink communication.

As disclosed above, in some examples, the uplink transmission is either an uplink data transmission or a transmission of an uplink reference signal.

As disclosed above, in some examples, the uplink transmission is a codebook-based precoded uplink data transmission.

As disclosed above, in some examples, according to the configuration, the codebook-based precoded uplink data transmission is to be performed jointly over at least two of the transceiver devices 200 in the group of transceiver devices 200.

As disclosed above, in some examples, according to the configuration, non-coherent codebook-based precoded uplink data transmission is to be performed over antenna ports belonging to different ones of the transceiver devices 200 in the group of transceiver devices 200.

As disclosed above, in some examples, according to the configuration, non-coherent, partially-coherent, or fully-coherent codebook-based precoded uplink data transmission is to be performed over antenna ports belonging to one and the same transceiver device 200 in the group of transceiver devices 200.

As disclosed above, in some examples, the uplink transmission is a non-codebook-based precoded uplink data transmission.

As disclosed above, in some examples, according to the configuration, one uplink reference signal resource or a common set of uplink reference signal resources is configured over the transceiver devices 200 in the group of transceiver devices 200.

Embodiments, aspects, and examples as applicable to both the transceiver devices 200 and the network node 300, and the corresponding methods, will be disclosed next.

Since different devices might have different output power capabilities, different coherency capabilities, etc., the network node 300 is in some aspects aware of which SRS resource, or SRS port, that corresponds to which transceiver device 200. In one example, there is an implicit mapping between the SRS ports numbering and the transceiver devices 200. For example, in the device capability signaling, an explicit or implicit number (where the implicit number for example could be based on in which order the devices capabilities are signaled in) could be indicated per transceiver device 200. Then there could be an implicit mapping between the SRS ports and the transceiver devices 200, for example such that the SRS port, or ports, with lowest number are allocated to the transceiver device 200 with lowest number. In another example, there is an explicit association between the SRS resources/ports and the network node 300. This could for example be realized during radio resource control (RRC) configuration of the SRS resources/ports, where for example each SRS resource/port is configured with a device number.

In some examples, all antenna ports over all transceiver devices 200 are sounded (and hence, the SRS transmission overhead remains unchanged). However, the uplink data transmission can be done only by the transceiver device 200 that has the best channel available. This could improve performance for the transceiver devices 200 with poor channel conditions (e.g., transceiver devices 200 that suffer from deep fading). Hence, in some examples, SRSs are transmitted from all transceiver devices 200 but PUSCH is only transmitted from one of the transceiver devices 200.

In a first example, consider a scenario in which three transceiver devices 200 are active but are transmitting and/or receiving data at a low rate, as in FIG. 1. According to a traditional NR scheme, if each of the transceiver devices 200 is configured with codebook-based PUSCH, each transceiver devices 200 needs to transmit SRS and PUSCH (and receive signaling from the network node 300 on how to do so). The minimum total number of uplink layers in this example would be 3, one for each of the transceiver devices 200. If the three transceiver devices 200 would form a RVUE 400, as in FIG. 2, the minimum total number of uplink layers would instead be 1, i.e., one layer. With the herein disclosed inventive concept, as illustrated in FIG. 2, UE 1 and UE 2 may relay their uplink data to UE 0 which, in turn, performs the uplink transmission on behalf of all the transceiver devices 200. With this, the SRS overhead can be reduced from 4 SRS ports (corresponding to all four antenna ports over all three transceiver devices 200) to 2 SRS ports (corresponding to the two antenna ports in the panel of UE 0), which will reduce the risk of SRS congestion.

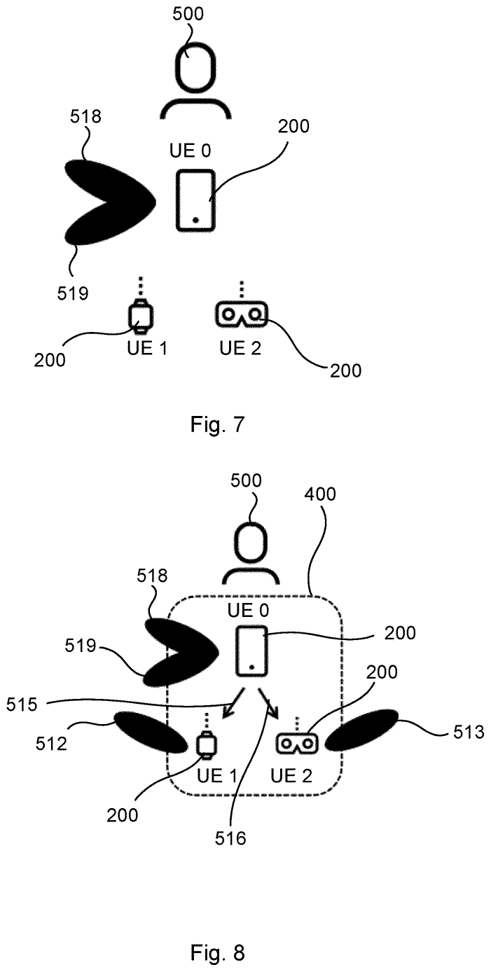

In a second example, consider a scenario in which three transceiver devices 200 are active but, only one of the transceiver devices 200, UE 0, needs to transmit data at a high rate as in FIG. 7, where UE 0 is communicating in beams 518, 519. According to a traditional NR scheme, since UE 0 is equipped with only two antenna ports, a maximum of 2 uplink layers is supported. However, in case UE 0 coveys some of its uplink data to UE 1 and UE 2, as in FIG. 8 where the three transceiver devices 200 are configured as one RVUE 400, the combined number of antenna ports are increased to 4. This increases the maximum number of supported uplink layers to 4, which could lead to higher user throughput for UE 0.

In some aspects, since the conveying of data from one transceiver device 200 to another transceiver device 200 is associated with an extra delay, the delay requirement from the scheduling downlink control information (DCI) to the actual data transmission could be relaxed. That is, the minimum delay between the DCI that triggers the uplink transmission, and the actual uplink transmission is increased when the uplink transmission is performed over multiple transceiver devices 200.

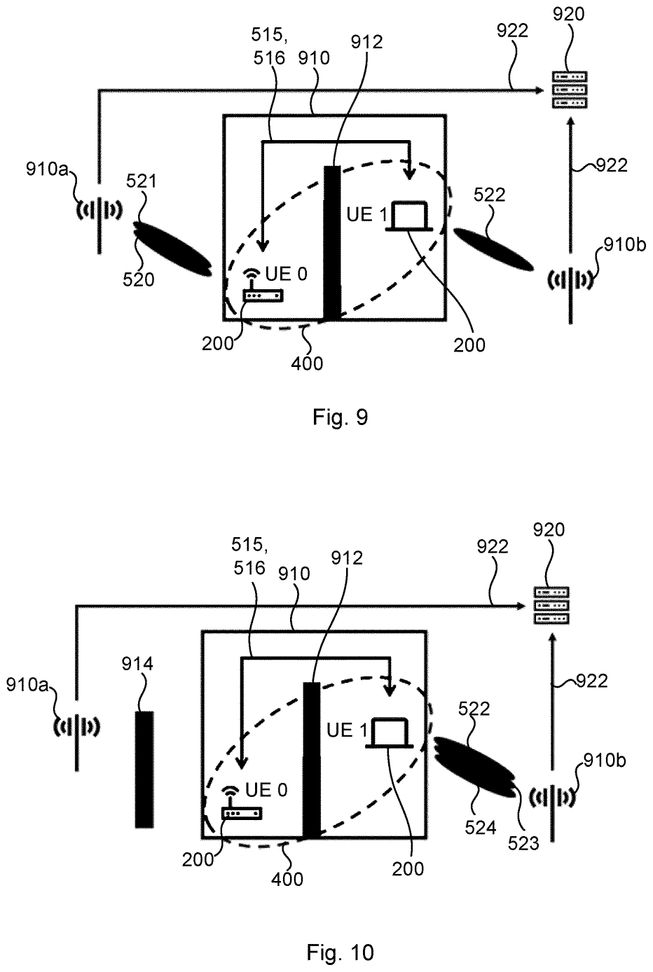

In a third example, a transceiver device 200 in the form of a cellular modem/router (UE 0) and a transceiver device 200 in the form of a laptop computer (UE 1) are configured as an RVUE 400, as in FIG. 9. The laptop computer (possibly along with several other devices that do not have any cellular-communication capabilities) connects to the local area network (LAN) provided by the cellular modem/router (UE 0). UE 0 and UE 1 are thereby inter-connected via some none-cellular interface (e.g., Wi-Fi or Ethernet) as indicated by link 515, 516. UE 0 and UE 1 are illustrated as situated on different sides of a blocking wall 912 in a room 910, and therefore their respective preferred connections are to different transmission points (TRPs) 910a, 910b. The TRPs 910a, 910b are operatively connected over links 922 to a shared baseband-processing unit 920 in a cellular network. In the illustrative example of FIG. 9, UE 0 is configured for uplink transmission in two layers, as represented by beams 520, 521, whereas UE 1 is configured for uplink transmission in only one single layer, as represented by beam 522. Configuring UE 0 and UE 1 as a RVUE 400 results in improved coverage for UE 0 and UE 1. To illustrate this, consider the situation in FIG. 10 where the operative connection between UE 0 and its serving TRP 910a has been interrupted by a blocker 914. If UE 1 is capable of uplink transmission using three layers, as represented by beams 522, 523, 524, UE 0 can reroute its uplink traffic to UE 1 to retain a connection to the cellular network, where the uplink transmission from UE 1 in one of the three layers belong to UE 0.

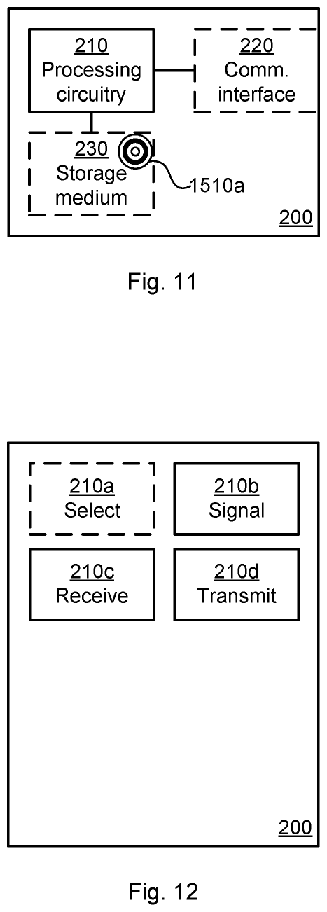

FIG. 11 schematically illustrates, in terms of a number of functional units, the components of a transceiver device 200 according to an embodiment. Processing circuitry 210 is provided using any combination of one or more of a suitable central processing unit (CPU), multiprocessor, microcontroller, digital signal processor (DSP), etc., capable of exe cuting software instructions stored in a computer program product 1510a (as in FIG. 15), e.g. in the form of a storge medium 230. The processing circuitry 210 may further be provided as at least one application specific integrated circuit (ASIC), or field programmable gate array (FPGA).

Particularly, the processing circuitry 210 is configured to cause the transceiver device 200 to perform a set of operations, or steps, as disclosed above. For example, the storage medium 230 may store the set of operations, and the processing circuitry 210 may be configured to retrieve the set of operations from the storage medium 230 to cause the transceiver device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The transceiver device 200 may further comprise a communications (comm.) interface 220 for communications with other entities, functions, nodes, and devices, such as other transceiver devices 200 as well as the network node 300. As such the communications interface 220 may comprise one or more transmitters and receivers, comprising analogue and digital components.

The processing circuitry 210 controls the general operation of the transceiver device 200 e.g. by sending data and control signals to the communications interface 220 and the storage medium 230, by receiving data and reports from the communications interface 220, and by retrieving data and instructions from the storage medium 230. Other components, as well as the related functionality, of the transceiver device 200 are omitted in order not to obscure the concepts presented herein.

FIG. 12 schematically illustrates, in terms of a number of functional modules, the components of a transceiver device 200 according to an embodiment. The transceiver device 200 of FIG. 12 comprises a number of functional modules; a signal module 210b configured to perform step S104, a receive module 210c configured to perform step S106, and a transmit module 210d configured to perform step S108. The transceiver device 200 of FIG. 12 may further comprise a number of optional functional modules, such as a select module 210a configured to perform step S102. In general terms, each functional module 210a:210d may be implemented in hardware or in software. Preferably, one or more or all functional modules 210a:210d may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210d and to execute these instructions, thereby performing any steps of the transceiver device 200 as disclosed herein.

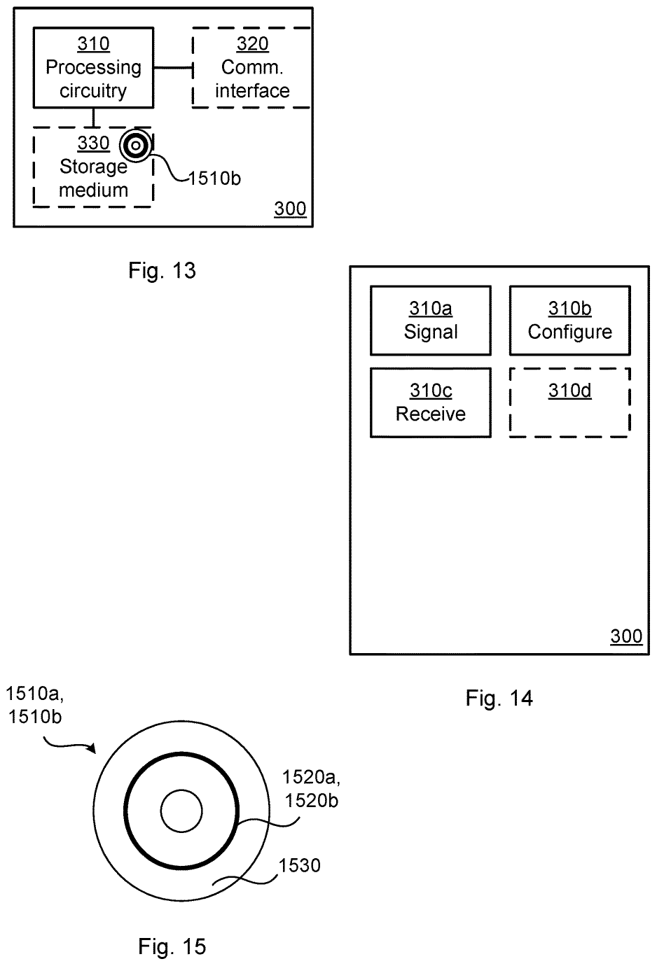

FIG. 13 schematically illustrates, in terms of a number of functional units, the components of a network node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1510b (as in FIG. 15), e.g. in the form of a storage medium 330. The processing circuitry 310 may further be provided as at least one application specific integrated circuit (ASIC), or field programmable gate array (FPGA).

Particularly, the processing circuitry 310 is configured to cause the network node 300 to perform a set of operations, or steps, as disclosed above. For example, the storage medium 330 may store the set of operations, and the processing circuitry 310 may be configured to retrieve the set of operations from the storage medium 330 to cause the network node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The network node 300 may further comprise a communications interface 320 for communications with other entities, functions, nodes, and devices, such as with individual transceiver devices 200 as well as with an RVUE 400 constituted by a group of transceiver devices 200. As such the communications interface 320 may comprise one or more transmitters and receivers, comprising analogue and digital components.

The processing circuitry 310 controls the general operation of the network node 300 e.g. by sending data and control signals to the communications interface 320 and the storage medium 330, by receiving data and reports from the communications interface 320, and by retrieving data and instructions from the storage medium 330.

Other components, as well as the related functionality, of the network node 300 are omitted in order not to obscure the concepts presented herein.

FIG. 14 schematically illustrates, in terms of a number of functional modules, the components of a network node 300 according to an embodiment. The network node 300 of FIG. 14 comprises a number of functional modules; a signal module 310a configured to perform step S202, a configure module 310b configured to perform step S204, and a receive module 310c configured to perform step S206. The network node 300 of FIG. 14 may further comprise a number of optional functional modules, as represented by functional module 310d. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the network node 300 as disclosed herein.

The network node 300 may be provided as a standalone device or as a part of at least one further device. For example, the network node 300 may be provided in a node of a (radio) access network or in a node of a core network. Alternatively, functionality of the network node 300 may be distributed between at least two devices, or nodes. These at least two nodes, or devices, may either be part of the same network part (such as the (radio) access network or the (core) network) or may be spread between at least two such network parts. In general terms, instructions that are required to be performed in real time may be performed in a device, or node, operatively closer to a cell served by the network node 300 than instructions that are not required to be performed in real time.

Thus, a first portion of the instructions performed by the network node 300 may be executed in a first device, and a second portion of the instructions performed by the network node 300 may be executed in a second device; the herein disclosed embodiments are not limited to any particular number of devices on which the instructions performed by the network node 300 may be executed. Hence, the methods according to the herein disclosed embodiments are suitable to be performed by a network node 300 residing in a cloud computational environment. Therefore, although a single processing circuitry 310 is illustrated in FIG. 13 the processing circuitry 310 may be distributed among a plurality of devices, or nodes. The same applies to the functional modules 310a:310d of FIG. 14 and the computer program 1520b of FIG. 15.

FIG. 15 shows one example of a computer program product 1510a, 1510b comprising computer readable means 1530. On this computer readable means 1530, a computer program 1520a can be stored, which computer program 1520a can cause the processing circuitry 210 and thereto operatively coupled entities and devices, such as the communications interface 220 and the storage medium 230, to execute methods according to embodiments described herein. The computer program 1520a and/or computer program product 1510a may thus provide means for performing any steps of the transceiver device 200 as herein disclosed. On this computer readable means 1530, a computer program 1520b can be stored, which computer program 1520b can cause the processing circuitry 310 and thereto operatively coupled entities and devices, such as the communications interface 320 and the storage medium 330, to execute methods according to embodiments described herein. The computer program 1520b and/or computer program product 1510b may thus provide means for performing any steps of the network node 300 as herein disclosed.

In the example of FIG. 15, the computer program product 1510a, 1510b is illustrated as an optical disc, such as a CD (compact disc) or a DVD (digital versatile disc) or a Blu-Ray disc. The computer program product 1510a, 1510b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1520a, 1520b is here schematically shown as a track on the depicted optical disk, the computer program 1520a, 1520b can be stored in any way which is suitable for the computer program product 1510a, 1510b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-33. (canceled)

34. A method for uplink communication with a network node, wherein the method is performed by a first transceiver device, the method comprising:
exchanging signaling with the network node to form a reconfigurable virtual user equipment (RVUE) comprising a group of transceiver devices, the group of transceiver devices comprising the first transceiver device and a second transceiver device, and wherein the signaling at least indicates available number of antenna ports of the RVUE for communication with the network node, and maximally support transmission rank for the RVUE;
receiving configuration from the network node for uplink transmission from the R VUE to the network node, wherein the configuration at least indicates which transmission rank for the RVUE to use, and a mapping of transmission layers to the antenna ports in the RVUE; and
performing uplink transmission towards the network node in accordance with the received configuration.

35. The method of claim 34, wherein the signaling further indicates:
number of transceiver devices in the group of transceiver devices,
number of antenna ports per transceiver device in the group of transceiver devices,
supported bandwidth per transceiver device in the group of transceiver devices,
coherency capability per transceiver device in the group of transceiver devices,
maximum transmit power per transceiver device in the group of transceiver devices, and/or
which uplink reference signal resource, or port, that corresponds to which transceiver device in the group of transceiver devices.

36. The method of claim 34, wherein
the available number of antenna ports is less than total number of antenna ports of the RVUE, and
the method further comprises selecting the available antenna ports from the total antenna ports of the RVUE.

37. The method of claim 36, wherein the selecting is based on:
signal quality, and/or
capacity of signaling interfaces between the transceiver devices in the group of transceiver devices.

38. The method of claim 34, wherein the uplink transmission is a codebook-based precoded uplink data transmission.

39. The method of claim 38, wherein, according to the configuration, the codebook-based precoded uplink data transmission is to be performed jointly over at least two of the transceiver devices in the group of transceiver devices.

40. The method of claim 39, wherein, according to the configuration, non-coherent codebook-based precoded uplink data transmission is to be performed over antenna ports belonging to different ones of the transceiver devices in the group of transceiver devices.

41. The method of claim 39, wherein, according to the configuration, non-coherent, partially-coherent, or fully-coherent codebook-based precoded uplink data transmission is to be performed over antenna ports belonging to one and the same transceiver device in the group of transceiver devices.

42. The method of claim 34, wherein the uplink transmission is a non-codebook-based precoded uplink data transmission.

43. The method of claim 34, wherein at least one of the transceiver devices in the group of transceiver devices comprises a cellular modem and has a cellular network identity.

44. The method of claim 34, wherein each of the transceiver devices in the group of transceiver devices comprises a signaling interface for non-cellular communication with other transceiver devices in the group of transceiver devices.

45. A method performed by a network node, the method comprising:
exchanging signaling with a first transceiver device to form a reconfigurable virtual user equipment (RVUE) comprising a group of transceiver devices, the group of transceiver devices comprising the first transceiver device and a second transceiver device, wherein the signaling at least indicates available number of antenna ports of the RVUE for communication with the network node, and maximally support transmission rank for the RVUE;
configuring the RVUE for uplink transmission from the RVUE to the network node as a function of the available number of antenna ports of the RVUE, and the maximally support transmission rank, wherein the configuring at least indicates which transmission rank for the RVUE to use, and a mapping of transmission layers to the antenna ports in the RVUE; and
receiving uplink transmission from the RVUE in accordance with the configuration.

46. The method of claim 45, wherein the signaling further indicates:
number of transceiver devices in the group of transceiver devices,
number of antenna ports per transceiver device in the group of transceiver devices,
supported bandwidth per transceiver device in the group of transceiver devices,
coherency capability per transceiver device in the group of transceiver devices,
maximum transmit power per transceiver device in the group of transceiver devices, and/or
which uplink reference signal resource, or port, that corresponds to which transceiver device in the group of transceiver devices.

47. The method of claim 45, wherein the uplink transmission is a codebook-based precoded uplink data transmission.

48. The method of claim 47, wherein, according to the configuration, the codebook-based precoded uplink data transmission is to be performed jointly over at least two of the transceiver devices in the group of transceiver devices.

49. The method of claim 48, wherein, according to the configuration, non-coherent codebook-based precoded uplink data transmission is to be performed over antenna ports belonging to different ones of the transceiver devices in the group of transceiver devices.

50. The method of claim 48, wherein, according to the configuration, non-coherent, partially-coherent, or fully-coherent codebook-based precoded uplink data transmission is to be performed over antenna ports belonging to one and the same transceiver device in the group of transceiver devices.

51. The method of claim 45, wherein the uplink transmission is a non-codebook-based precoded uplink data transmission.

52. A transceiver device for uplink communication with a network node, the transceiver device comprising:
memory; and
processing circuitry, wherein the transceiver device is configured to perform a method comprising:
exchanging signaling with the network node to form a reconfigurable virtual user equipment (RVUE) comprising a group of transceiver devices, the group of transceiver devices comprising the first transceiver device and a second transceiver device, and wherein the signaling at least indicates available number of antenna ports of the RVUE for communication with the network node, and maximally support transmission rank for the RVUE;
receiving configuration from the network node for uplink transmission from the RVUE to the network node, wherein the configuration at least indicates which transmission rank for the RVUE to use, and a mapping of transmission layers to the antenna ports in the RVUE; and
performing uplink transmission towards the network node in accordance with the received configuration.

53. A network node, the network node comprising:
memory; and
processing circuitry, wherein the network node is configured to perform a method comprising:
exchanging signaling with a first transceiver device to form a reconfigurable virtual user equipment (RVUE) comprising a group of transceiver devices, the group of transceiver devices comprising the first transceiver device and a second transceiver device, wherein the signaling at least indicates available number of antenna ports of the RVUE for communication with the network node, and maximally support transmission rank for the RVUE;
configuring the RVUE for uplink transmission from the RVUE to the network node as a function of the available number of antenna ports of the RVUE, and the maximally support transmission rank, wherein the configuring at least indicates which transmission rank for the RVUE to use, and a mapping of transmission layers to the antenna ports in the RVUE; and
receiving uplink transmission from the RVUE in accordance with the configuration.

54. A non-transitory computer readable storage medium storing instructions for configuring a first transceiver device comprising processing circuitry operable to execute the instructions to perform the method of claim 34.

55. A non-transitory computer readable storage medium storing instructions for configuring a network comprising processing circuitry operable to execute the instructions to perform the method of claim 45.
